(19) United States
(12) Patent Application Publication
(10) Pub. No.: US 2015/0376805 A1
(43) Pub. Date: Dec. 31, 2015

(54) ELECTROCHEMICAL DEVICE FOR RECOVERING URANIUM

(71) Applicant: KOREA ADVANCED INSTITUTE OF SCIENCE AND TECHNOLOGY, Yuseong-gu, Daejeon (KR)

(72) Inventors: Man Sung YIM, Daejeon (KR); Riley Martin CUMVERLAND, Daejeon (KR)

(73) Assignee: KOREA ADVANCED INSTITUTE OF SCIENCE AND TECHNOLOGY, Daejeon (KR)

(21) Appl. No.: 14/651,062

(22) PCT Filed: Jul. 29, 2013
(86) PCT No.: PCT/KR2013/006754

§ 371 Date: Jun. 10, 2015

(30) Foreign Application Priority Data
Dec. 10, 2012 (KR) 10-2012-0142806

(51) Int. Cl. C25C 3/34; G21C 19/50; C25C 7/00

(52) U.S. Cl. CPC C25C 3/34; C25C 7/005; G21C 19/50

(57) ABSTRACT

The present invention relates to an electrochemical device, and more particularly, to an electrochemical device for recovering uranium from spent nuclear fuel, including: an electrolytic bath containing a molten salt electrolyte solution; a flow barrier which divides the electrolytic bath into two chambers and limits a flow of the electrolyte solution; a filter which filters particulates from the flow of the electrolyte solution; an anode which is inserted into the molten salt from one side of the electrolytic bath; and a cathode which is inserted into the molten salt from the other side of the electrolytic bath.

### TECHNICAL FIELD

The present invention relates to an electrochemical device, and more particularly, to an electrochemical device for recovering uranium from spent nuclear fuel, including: an electrolytic bath containing a molten salt electrolyte solution; a flow barrier which divides the electrolytic bath into two chambers and partially limits a flow of the electrolyte solution; a filter which filters particulates from the flow of the electrolyte solution; an anode which is inserted into the molten salt from one side of the electrolytic bath; and a cathode which is inserted into the molten salt from the other side of the electrolytic bath. The device of the present invention may also remove particulates by contacting the electrolyte solution with liquid metal using some form of contactor instead of including the filter.

### BACKGROUND ART

In the case of a high temperature electrochemical process of recovering uranium from spent nuclear fuel, the accumulation of impurities typically occurs.

In general, a bath of molten salt containing the combination of LiCl, KCl, MgCl₂, NaCl, CaCl, or other alkaline metal/halogen compounds is used in the high temperature electrochemical processing of spent nuclear fuel. At this time, chemical reactions occurring in the system are facilitated by adding some other chlorides such as UCl₃ to the salt.

Two electrodes are used in the bath of molten salt. The more positively charged electrode is known as the anode which is composed mostly of uranium metal and small amounts of other components and includes spent nuclear fuel. The more negatively charged electrode is known as the cathode which is typically a piece of steel, graphite, or tungsten, which is inserted into the salt.

FIG. 1 is a conceptual view of an electrochemical cell for reprocessing spent nuclear fuel according to the prior art.

When an electrical circuit is formed in the bath of molten salt, uranium and active metal species such as plutonium from the anode are dissolved into the molten salt. Thereafter, only uranium is deposited on the cathode, and irregularly shaped dendrites are often formed. Uranium deposited on the cathode is recovered from an electrochemical cell through a scraper/collection basket for additional processing.

Metal uranium is oxidized to UCl₃ by a positive potential which is applied to an anode of an electrorefiner.

The following reaction typically occurs between chlorine atoms which are already present in the molten salt and metal uranium.

U(solid)+3Cl⁻ (liquid)−>UCl₃ (liquid)+3e⁻ (1)

More active chemical species are also typically oxidized in the molten salt to produce a molten metal chloride. Plutonium reacts as follows in the same manner as uranium.

Pu(solid)+3Cl⁻(liquid)−>PuCl₃(liquid)+3e⁻ (2)

Less active chemical species (chemical species less active than UCl3) such as zirconium are not oxidized, but may be eroded from the anode by loss of other materials. These become a source of particulate materials which may contaminate the product from the cathode. Noble components of the anode are not dissolved in electrolyte. Rather, these remain as metals or oxides to be remaining on the anode or precipitate to the bottom of the bath of molten salt, or form particulates included in the molten salt. Thereafter, these particulates enter the cathode or a uranium product collection basket in some cases to contaminate a final product of the process.

UCl₃ is reduced as in the following Reaction Formula (3) by a negative potential which is applied to the cathode, thereby forming uranium metal.

UCl₃(liquid)+3e⁻−>U(solid)+3Cl⁻(liquid) (3)

In the molten salt, chemical species less active than UCl₃ are reduced to become metals. When less active chemical species are present in an electrolyte such as metal chloride, the species react with the cathode to form a metal produce in a manner similar to the uranium deposition.

A deposit of dendrites is frequently formed on the cathode, and particulates may be captured in the dendrites, thereby contaminating the product. Accordingly, any separation method is needed, but electrical charges need to be continuously moved. Therefore, it is considered to prevent this phenomenon by using a flow barrier in the present invention.

U.S. Pat. No. 7,799,185 discloses a method and a device for recovering a trace of an actinium element and a transuranic element from a molten salt electrolyte, including an electrolytic bath, a first porous vessel, a second porous vessel, a cathode, and one or more anodes.

In the U.S. Pat. No. 7,799,185, a porous membrane functions as a barrier for some dissolved chemical species, but is disadvantageous in that the porous membrane fails to treat impurity particulates in a bath system of molten salt, and has a complex structure.

The present inventor has noted that a bath system of molten salt having a simple structure may block the flow of impurity particulates by applying a filter other than a flow barrier to the bath system of molten salt, or contacting the electrolyte solution with liquid metal using some form of contactor, thereby completing the present invention.

### DISCLOSURE OF INVENTION

### Technical Problem

A technical problem to be solved by the present invention is to provide an electrochemical device for recovering uranium from spent nuclear fuel, including an electrolytic bath containing a molten salt electrolyte solution; a porous flow barrier which divides the electrolytic bath into two chambers and limits a flow of the electrolyte solution; an anode which is inserted into the molten salt from one side of the electrolytic bath; and a cathode which is inserted into the molten salt from the other side of the electrolytic bath, in which particulates are removed while molten salt and molten metal are brought into contact with each other in a flow path in which the electrolyte solution is pumped from one side of the electrolytic bath, through a liquid-liquid contactor, and into the other side of the electrolytic bath (see FIG. 2).

A technical problem to be solved by the present invention is to provide a device which is a modified form of the above-described device, including: an electrolytic bath containing a molten salt electrolyte solution; a flow barrier which divides the electrolytic bath into two chambers and limits a flow of the electrolyte solution; a filter which filters particulates from the flow of the electrolyte solution; an anode which is inserted into the molten salt from one side of the electrolytic bath; and a cathode which is inserted into the molten salt from the other side of the electrolytic bath (see FIG. 3).

It is possible to recover uranium without being contaminated by impurities through devices of the present invention.

### Solution to Problem

An embodiment of the present invention relates to an electrochemical device for recovering uranium from spent nuclear fuel, including: an electrolytic bath containing a molten salt electrolyte solution; a flow barrier which divides the electrolytic bath into two chambers and partially limits the flow of the electrolyte solution; a filter which filters particulates from the flow of the electrolyte solution; an anode which is inserted into the molten salt from one side of the electrolytic bath; and a cathode which is inserted into the molten salt from the other side of the electrolytic bath.

The electrochemical device for recovering uranium of the present invention may additionally include a pump which transfers the molten salt electrolyte solution in the chamber including the cathode to the chamber including the anode. It is possible to maintain the flow of the molten salt electrolyte solution through the flow barrier and the filter by using the pump.

The flow barrier is a barrier for the rapid movement of particulates. However, it is possible to achieve electrical conduction and material transfer of soluble chemical species through the flow barrier. The filter and the pump operate as means for supplying the electrolyte containing dissolved uranium to the cathode, and the flow toward the cathode through the barrier is additionally reduced by the positive pressure on the cathode side of the porous flow barrier. The positive pressure is due to the pump.

The flow barrier includes tiny chambers (less than 2 mm) which are connected to each other and empty therein, and may also be made of any material that has corrosion resistance in a molten salt electrolyte.

For example, the flow barrier may be made of a ceramic material such as alumina, magnesia, berylia, silica, or zirconia. If the flow barrier is prevented from becoming an intermediate electrode, the flow barrier may be made of a metal such as stainless steel or tungsten. Any material may be used as a flow barrier material as long as the material may endure high temperature and chemical conditions, is hollow, and has an interconnected space for the fluid to flow through.

For example, the flow barrier may be in the form of a fiber-based product, such as a screen mesh, a rigid piece of porous media, or a ceramic felt.

The flow barrier does not affect any dissolved components that pass through the barrier. Further, diffusion is not important in the operation of the flow barrier because mass is transported through bulk fluid motion alone. The flow barrier provides interconnected chambers of electrolyte which provide a electrical conduction pathway.

Accordingly, the flow barrier serves a role of blocking a rapid movement of a fluid containing particulates while allowing current to be uniformly conducted. For example, pores in the felt are connected with each other and electrical contact is present through the felt, and thus current may flow. For this reason, a flow barrier made of felt enables electric charge to move, but the small pore size limits the movement of a solid material, additionally the small pore size creates a lot of friction making the entire flow speed very slow. Further, the movement of solid particulates may be blocked by the flow in the opposite direction.

In other words, passing through the flow barrier by diffusion has nothing to do with the type of dissolved chemical species. The use of the flow barrier enables current to uniformly flow while considerably delaying or even stopping the entire flow of the fluid. However, the corrosion of the flow barrier may be problematic. It is possible to use inert ceramic, metal, or graphite which is porous, and these materials will operate in the same manner as the felt membrane.

In addition, metal, carbon, or inert ceramic screen (mesh) may also be used for the purpose of a flow barrier because these materials increase flow resistance, thereby limiting the flow of the fluid. Furthermore, the introduction of a back pressure hinders or reverses the flow in the normal direction, which passes through the screen (this is similar to the case of the felt flow barrier).

The filter may be manufactured in any form, but it is preferred that the filter is manufactured in a reusable form. Further, it is preferred that the filter is made of a material with which there is no concern of corrosion because durability is desired.

Specifically, a material for the filter may be ceramic fiber, porous ceramic, fiber glass, or a carbon material. A filter may be made of these materials for manufacturing a filter in the form of a screen mesh or fiber blanket.

An object of the filter is to transfer UCl₃ and other dissolved components to the cathode while trapping particulates. When the flow of UCl₃ and other dissolved components is stopped, the electrochemical system will begin to function inappropriately.

Accordingly, it is insufficient to apply only the flow barrier to the present system. However, since the flow barrier material and the filter material are similar to each other, the flow barrier and the filter may be combined with each other and operate like a part (see FIG. 3).

The anode is composed mostly of uranium metal and small amounts of some constituent components, and the cathode is typically composed of steel, graphite, or tungsten, which is inserted into the salt.

Some filters which may be used in the device of the present invention are as follows:
1. Molten metal filter
   i) Passing through a tortuous route next to the molten metal to guide the salt.
   ii) As a modification of 1.i), the filtration ability is improved by bubbling the molten salt through the molten metal to increase a ratio of the surface area to the volume.
2. Filter in a general form (for example, cartridge filter)
   i) Fiber-based filter
      a) Metal-based fiber (not preferable)
      b) Inert ceramic-based filter (preferable)
   ii) Porous material
      a) Porous metal (not preferable)
      b) Porous inert ceramic (preferable)
   iii) Packed granule/powder material
      a) Packed granule/powder metal
      b) Packed granule/powder inert ceramic (preferable)

When the molten salt is pumped around the molten metal (the two liquids are not mixed with each other), metal particulates are attached to the molten metal by the increased surface tension of the molten metal. Most of the metal is dissolved in the molten metal, but is not dissolved in the molten salt, meaning that the intermolecular force between the metal atom and the noble metal particulate is stronger than the intermolecular force between the salt atom and the noble metal particulate. This suggests that the surface tension between the metal particulate and the molten metal is stronger than the surface tension between the metal particulate and the molten salt. The filter of the present invention does not include a cartridge, and thus need not to be treated as radioactive waste.

The route of the flow may be made of an inert ceramic such as berylia, or other materials which do not react. The bath of molten salt is made of a low melting point metal such as zinc, cadmium, tin, or lead. The molten salt may be LiCl—KCl eutectic, or molten salt (MgCl₂—KCl and the like) having a different form according to a desired physical property.

Another object of the present invention may be achieved by providing an electrochemical device for recovering uranium from spent nuclear fuel, including an electrolytic bath containing a molten salt electrolyte solution; a flow barrier which divides the electrolytic bath into two chambers and limits a flow of the electrolyte solution; an anode which is inserted into the molten salt from one side of the electrolytic bath; and a cathode which is inserted into the molten salt from the other side of the electrolytic bath, in which particulates are removed while molten salt and molten metal are brought into contact with each other in a flow path in which the electrolyte solution is flowed from one side of the electrolytic bath into the other side of the electrolytic bath.

In the present invention, the fact that particulates are removed by flowing the electrolyte solution from one side of the electrolytic bath to the other side of the electrolytic bath means that a method of connecting molten salt to molten metal is used in order to remove particulates in the molten salt. The removal of particulates by using molten metal may include a flow path which guides the transfer of the molten salt, molten salt and molten metal which flow in the flow path, and a pump which injects the molten salt into the flow path (see FIGS. 3A and 3B). The molten metal serves to remove particulates in the molten salt while being brought in contact with the molten salt.

Most of the metals are insoluble in molten salt, but soluble in molten metal. That is, the intermolecular force between metal atoms and noble metal particulates is stronger than the intermolecular force between salt atoms and noble metal particulates. Accordingly, when the molten salt is injected into a flow path in which the molten metal is present, the molten salt and the molten metal are not mixed with each other, but noble metal particulates present in the molten salt are introduced into the molten metal due to high surface tension of the molten metal and are dissolved therein. When the molten salt is brought into contact with the molten metal while continuously moving in the filter, noble metal particulates in the molten salt is removed (see FIG. 4).

It is possible to use zinc, cadmium, tin, or lead, which has a relatively low melting point as the molten metal material. In addition, alumina or stainless steel may be used as a structural material for providing the flow path. The molten salt may be LiCl—KCl eutectic.

An electrochemical device which does not include the filter of the present invention may additionally include a pump which transfers the molten salt electrolyte solution in the chamber including the cathode to the chamber including the anode. It is possible to maintain the flow of the molten salt electrolyte solution by the flow barrier and the filter by using the pump.

The flow barrier is a barrier for the rapid movement of particulates. The filter and the pump operate as means for supplying the electrolyte containing dissolved uranium to the cathode, and the flow toward the cathode of the barrier is additionally reduced by applying a positive pressure to the cathode of the flow barrier.

The flow barrier includes chambers which are connected to each other and empty therein, and may also be made of any material that has corrosion resistance in a molten salt electrolyte. For example, the porous flow barrier may be made of a ceramic material such as alumina, magnesia, berylia, silica, or zirconia. When the flow barrier may be prevented from becoming an intermediate electrode, the flow barrier may be formed of a metal such as stainless steel or tungsten.

The flow barrier may be in the form of a fiber-based product, such as a screen mesh, a rigid piece of porous media, or a ceramic felt.

The flow barrier serves as an electrical conductor in which a chemical reaction does not basically occur. because it is an object of the flow barrier to significantly slow or block the movement of a fluid containing particulates while allowing current to be uniformly conducted. However, bulk fluid motion between the anode and cathode will always be maintained by the pump and filter.

### Advantageous Effects of Invention

The device of the present invention may prevent impurities from being incorporated into a product, which is a problem in the related, and has an effect of reducing a manufacturing cost due to improved performance.

### BRIEF DESCRIPTION OF DRAWINGS

FIG. 1 is a conceptual view of an electrochemical cell for reprocessing spent nuclear fuel according to the prior art. When an anode begins to be dissolved, particulates are attached to a cathode.

FIG. 2 is one embodiment of the device according to the present invention, illustrating an electrochemical cell equipped with a flow barrier that also serves as a filter.

FIG. 3 is one embodiment of the device according to the present invention, illustrating an electrochemical cell in which the flow barrier operates as a barrier for the flow and particulates.

FIG. 4 illustrates a process in which noble metal particulates are captured in molten metal.

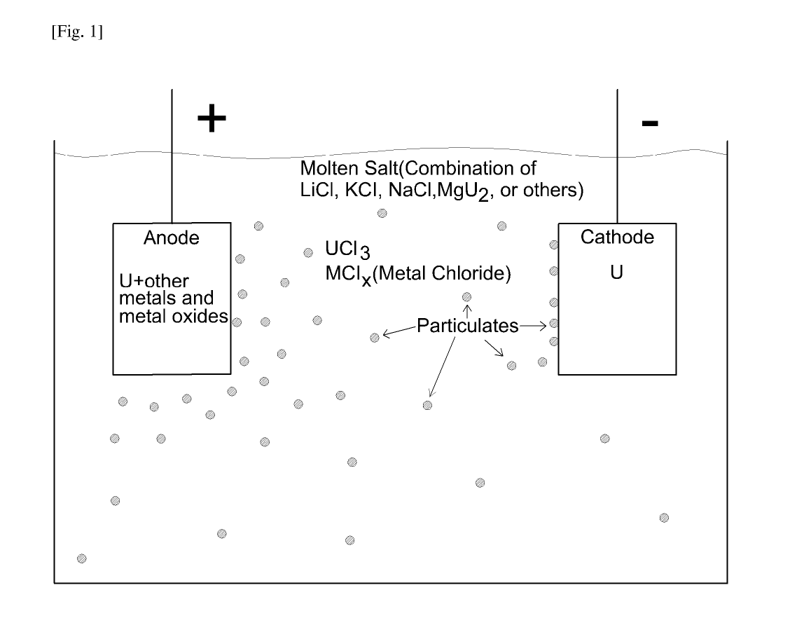

### BEST MODE FOR CARRYING OUT THE INVENTION

Hereinafter, the present invention will be described in more detail with reference to the following Examples. However, the following Examples are only a description for showing general embodiments of the present invention, and the scope of the present invention is not limited by the Examples.

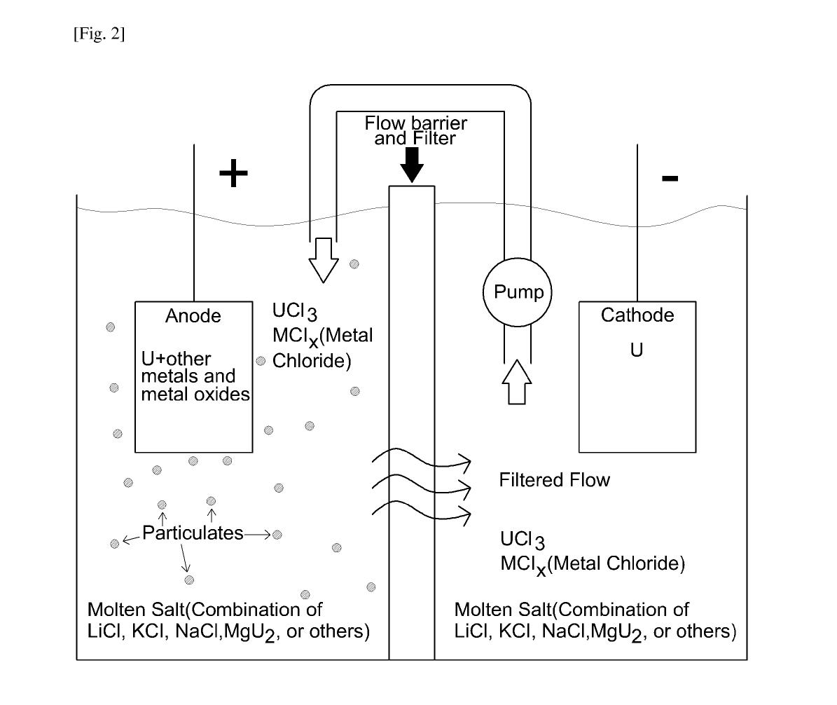

Referring to FIG. 2, one embodiment of the device of the present invention is illustrated. An electrolytic bath is filled with a molten salt electrolyte solution, and a flow barrier and a filter divide the bath into two chambers. An anode and a cathode are mounted on each chamber, and a pump and piping for transferring the electrolyte solution on the cathode side to the chamber on the anode side are illustrated.

The flow of the electrolyte solution from the anode side to the cathode side travels through the flow barrier. However, the flow barrier also has a function of limiting the flow of the electrolyte solution by any eddies or vortex flow in the reverse direction.

Further, the filter (not shown) blocks particulates in the chamber on the anode side from moving to the chamber on the cathode side. Whereby, only pure uranium is deposited on the cathode.

In addition, the pump serves to maintain the flow of the electrolyte solution from the anode side to the cathode side by transferring the solution in the chamber on the cathode side to the chamber on the anode side.

When an electrical circuit is formed in the bath system of molten salt of FIG. 2, uranium from the anode is dissolved along with an active metal species such as plutonium in the molten salt. Thereafter, only uranium is deposited on the cathode, and at this time, the deposited uranium often forms irregular dendrites. Uranium deposited on the cathode is recovered for an additional processing.

At the anode surface, uranium and some other metals from the anode lose electrons, and are bound to halogen atoms in the electrolyte. In the deposition reaction of the cathode, uranium atoms of UCl₃ obtain electrons again, and halogen atoms remain in the electrolyte.

A trace of some constituent components in the anode are not dissolved in the electrolyte and remain as metals or metal oxides, or precipitate to the bottom of the bath of molten salt, or form particulates incorporated in the molten salt. Because these particulates contaminate a final product of the process, contamination is prevented by using a filter to block these particulates from being brought into contact with the cathode.

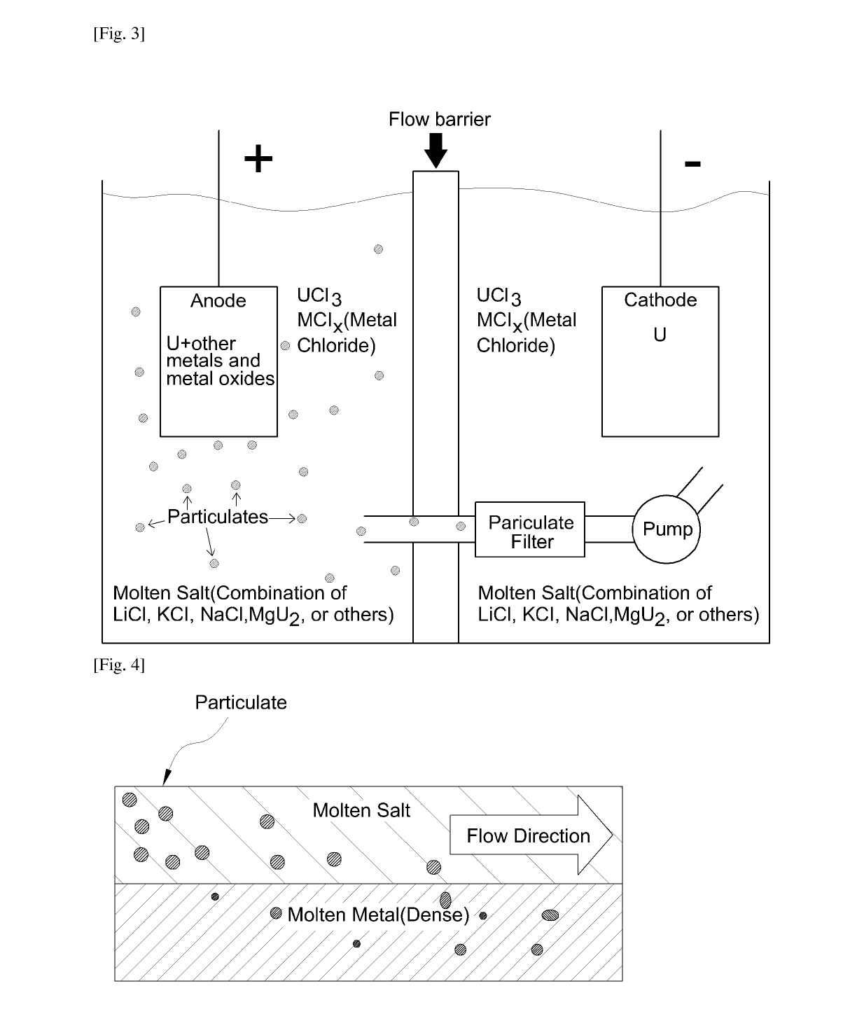

FIG. 3 is still another embodiment of the device of the present invention. As illustrated in FIG. 3, the filter and the pump are located along the pipe which passes through the flow barrier and connects both chambers to each other.

When the pump is actuated, a fluid including metal particulates moves from the anode chamber to cathode chamber, and at this time in the process, the metal particulates are filtered by the filter. The fluid present in an excessive amount on the cathode side moves to the anode side again through the flow barrier. The operation principle other than this is the same as the description of FIG. 2.

Furthermore, the electrochemical device for recovering uranium from spent nuclear fuel of the present invention may not include a filter. In this case, the device of the present invention is implemented such that particulates are removed while the electrolyte solution is flowed from one side of the electrolytic bath to the other side of the electrolytic bath.

The principle of removing particulates are illustrated in FIG. 4. Referring to FIG. 4, it can be seen that molten salt and molten metal are brought into contact with each other in the flow path, thereby removing noble metal particulates.

The flow path may be mounted on the flow barrier included in the device of the present invention, but is not limited thereto.

As described above, an embodiment of the present invention has been described, but it should be understood that those skilled in the art may modify and change the present invention in various ways without departing from the spirit of the present invention described in the claims by the addition, change, deletion or addition of constituent elements, and that the modifications and changes are included in the claims of the present invention.

1. An electrochemical device for recovering uranium from spent nuclear fuel, the device comprising:
an electrolytic bath containing a molten salt electrolyte solution;
A flow barrier that is containing voids (of less than 2 mm in size) which divides the electrolytic bath into two chambers and limits a flow of the electrolyte solution;
a filter which filters particulates from the flow of the electrolyte solution;
an anode which is inserted into the molten salt from one side of the electrolytic bath; and
a cathode which is inserted into the molten salt from the other side of the electrolytic bath.

2. The device of claim 1, further comprising a pump which transfers the molten salt electrolyte solution in the chamber comprising the cathode to the chamber comprising the anode.

3. The device of claim 1, wherein the flow barrier is selected from the group consisting of alumina, magnesia, berylia, silica, zirconia, stainless steel, monel, uranium oxide, thorium oxide, and tungsten.

4. The device of claim 1, wherein the flow barrier is in a form selected from the group consisting of a screen mesh, a rigid piece of porous media, and a ceramic felt.

5. The device of claim 1, wherein the filter is in a form of a screen mesh or a fiber blanket.

6. The device of claim 1, wherein the filter is made of a material selected from the group consisting of ceramic fiber, a porous ceramic, fiber glass, and carbon.

7. An electrochemical device for recovering uranium from spent nuclear fuel, the device comprising:
an electrolytic bath containing a molten salt electrolyte solution;
a flow barrier which divides the electrolytic bath into two chambers and limits a flow of the electrolyte solution;
an anode which is inserted into the molten salt from one side of the electrolytic bath; and
a cathode which is inserted into the molten salt from the other side of the electrolytic bath,
wherein particulates are removed while molten salt and molten metal are brought into contact with each other in a flow path in which the electrolyte solution is pumped from one side of the electrolytic bath, through a liquid-liquid contactor, and into the other side of the electrolytic bath.

8. The device of claim 7, further comprising a pump which transfers the molten salt electrolyte solution in the chamber comprising the cathode to the chamber comprising the anode.

9. The device of claim 7, wherein the flow barrier is selected from the group consisting of alumina, magnesia, berylia, silica, zirconia, yttrium oxides, thorium oxides, uranium oxides, stainless steel, monel, and tungsten.

10. The device of claim 7, wherein the flow barrier is in a form selected from the group consisting of a screen mesh, a rigid piece of porous media, and a ceramic felt.

11. The device of claim 7, wherein the molten metal is selected from the group consisting of zinc, cadmium, tin, and lead, antimony and other low melting alloys.

12. The device of claim 7, wherein the molten salt is LiCl—KCl eutectic.
